(19) United States
(12) Patent Application Publication
(10) Pub. No.: US 2016/0021517 A1
(43) Pub. Date: Jan. 21, 2016

(54) TERMINAL APPARATUS COMMUNICATING AMONG A PLURALITY OF TERMINAL APPARATUSES WITHIN A GROUP, COMMUNICATION SYSTEM, AND COMMUNICATION METHOD

(71) Applicant: JVC KENWOOD Corporation, Yokohama-shi (JP)

(72) Inventors: Atsushi SAITO, Yokohama-shi (JP); Hiroyuki NAKAJIMA, Yokohama-shi (JP); Kazuki MANNAMI, Yokohama-shi (JP); Shimpei KAMAYA, Yokohama-shi (JP); Yasuma SUZUKI, Yokohama-shi (JP); Makoto INADA, Yokohama-shi (JP)

(21) Appl. No.: 14/801,436

(22) Filed: Jul. 16, 2015

(30) Foreign Application Priority Data
Jul. 18, 2014 (JP) 2014-148198

(51) Int. Cl. H04W 4/08; H04W 4/02; H04L 29/08; H04W 4/00

(52) U.S. Cl. CPC H04W 4/08; H04W 4/008; H04W 4/02; H04L 67/104; H04W 88/02

(57) ABSTRACT

A second terminal apparatus, which is used in substitution for a first terminal apparatus that creates a group, collects a third terminal apparatus and so forth that are to be participated in the group. A first request signal receiver receives from the first terminal apparatus a first request signal by which to request the collection of the third terminal apparatus and so forth participated in the group. A second request signal transmitter transmits a second request signal by which to request the third terminal apparatus and so forth to participate in the group, when the first request signal receiver has received the first request signal.

### CROSS-REFERENCE TO RELATED APPLICATION

This application is based upon and claims the benefit of priority from the prior Japanese Patent Application No. 2014-148198, filed on Jul. 18, 2014, the entire contents of which are incorporated herein by reference.

### BACKGROUND

1. Field of the Invention

The present invention relates to a communication technology, and it particularly relates to a terminal apparatus communicating among a plurality of terminal apparatuses within a group, a communication system, and a communication method.

2. Description of the Related Art

In an individual telephone call in a wireless communication system, a telephone call is made between individual terminal apparatuses, based on an ID used to identify each terminal apparatus. In a group call in the wireless communication system, a plurality of terminal apparatuses belong beforehand to a certain group, and the calls are made simultaneously among a plurality of terminal apparatuses within this group. Also, the group needs to be dynamically changed depending on usage conditions. For example, a server apparatus stores the positional information on individual terminal apparatuses; when the latitude and longitude of the center of a circle as well as the radius R thereof are received from a terminal apparatus, terminal apparatuses having positional information where the distances from the center of the circle are less than the radius R are grouped together (see Reference (1) in the following Related Art List, for instance).

### RELATED ART LIST

(1) Japanese Unexamined Patent Application Publication 2009-260583.

There are cases where when a call is made from one terminal apparatus to another (a second terminal apparatus), a group call needs to be simultaneously made to other terminal apparatuses, which are located around the other terminal apparatus (the second terminal apparatus), in a service. When such a group call is necessary, a group needs to be formed in accordance with the positions where the terminal apparatuses are located.

### SUMMARY

In order to resolve the foregoing problems, a terminal apparatus according to one embodiment substitutes an initial terminal apparatus, which creates a group to be formed by a plurality of terminal apparatuses, and collects another terminal apparatus participating in the group, and the terminal apparatus includes: a request receiver that receives, from the initial terminal apparatus, a first request signal by which to request collection of the other terminal apparatus participating in the group; and a request transmitter that transmits a second request signal by which to request the other terminal apparatus to participate in the group, when the request receiver has received the first request signal.

Another embodiment relates to a communication system. The communication system includes: a first terminal apparatus that creates a group to be formed by a plurality of terminal apparatuses; and a second terminal apparatus that substitutes the first terminal apparatus and that collects another terminal apparatus participating in the group. The first terminal apparatus transmits a first request signal, by which to request collection of the other terminal apparatus participating in the group, to the second terminal apparatus and, when the second terminal apparatus has received the first request signal, the second terminal apparatus transmits a second request signal by which to request the other terminal apparatus to participate in the group.

Still another embodiment relates to a communication method. The method is a communication method carried out in a terminal apparatus that substitutes an initial terminal apparatus, which creates a group to be formed by a plurality of terminal apparatuses, and collects another terminal apparatus participating in the group, and the communication method includes: receiving, from the initial terminal apparatus, a first request signal by which to request collection of the other terminal apparatus participating in the group; and transmitting a second request signal by which to request the other terminal apparatus to participate in the group, when the first request signal has been received.

Still another embodiment relates also to a communication method. The communication method includes: transmitting a first request signal, by which to request collection of another terminal apparatus participating in the group, by a first terminal apparatus that creates a group to be formed by a plurality of terminal apparatuses; and transmitting a second request signal, by which to request the other terminal apparatus to participate in the group, by a second terminal apparatus that substitutes the first terminal apparatus and collects the other terminal apparatus participating in the group, when the first request signal has been received.

Optional combinations of the aforementioned constituting elements, and implementations of the invention in the form of methods, apparatuses, systems, recording media, computer programs and so forth may also be practiced as additional modes of the present invention.

### BRIEF DESCRIPTION OF THE DRAWINGS

Embodiments will now be described by way of examples only, with reference to the accompanying drawings, which are meant to be exemplary, not limiting and wherein like elements are numbered alike in several Figures in which:

FIG. 1 shows a structure of a communication system according to a first exemplary embodiment;

FIG. 2 shows a structure of the communication system shown in FIG. 1;

FIGS. 3A to 3D each shows a format of signal transmitted by the communication system shown in FIG. 1;

FIG. 4 shows a screen displayed on a display unit shown in FIG. 2;

FIG. 5 is a flowchart showing a procedure in which a second request signal is transmitted by a second terminal apparatus shown in FIG. 2;

FIG. 6 is a flowchart showing a procedure in which a first response signal is transmitted by a third terminal apparatus shown in FIG. 3;

FIG. 7 shows a structure of a communication system according to a second exemplary embodiment; and

FIG. 8 is a flowchart showing a procedure in which a first response signal is transmitted by a third terminal apparatus shown in FIG. 7.

### DETAILED DESCRIPTION

The invention will now be described by reference to the preferred embodiments. This does not intend to limit the scope of the present invention, but to exemplify the invention.

### First Exemplary Embodiment

The exemplary embodiment will be outlined before it is explained in detail. A first exemplary embodiment relates to a communication system that forms a group by a plurality of terminal apparatuses and performs a group call among the terminal apparatuses within the group. A description is given here centering around the processing of creating a group. In particular, an initial terminal apparatus, which makes a first call, has another terminal apparatus (hereinafter referred to as a “substituting terminal apparatus” or a “terminal apparatus acting on behalf of the initial terminal apparatus” also) included in the group and then intends to have other apparatuses, which are located around the substituting terminal apparatus, included in the group as well.

The initial terminal apparatus according to the first exemplary embodiment generates range data indicating a range where the substituting terminal apparatus is located in the center. The range indicated in the range data is a range that includes the positions of other terminal apparatuses to be included in the group. The initial terminal apparatus transmits a first request signal, which contains the range data, to the substituting terminal apparatus. When the first request signal is received, the substituting terminal apparatus broadcasts a second request signal that contains the information on the position, in which the substituting terminal is located, and the range data. Still another terminal apparatus, which has received the second request signal, identifies an area, based on the positional information and the range data contained in the second request signal. The other terminal apparatus (the still another terminal apparatus) acquires its own positional information and then participates in the group if it is located within the area.

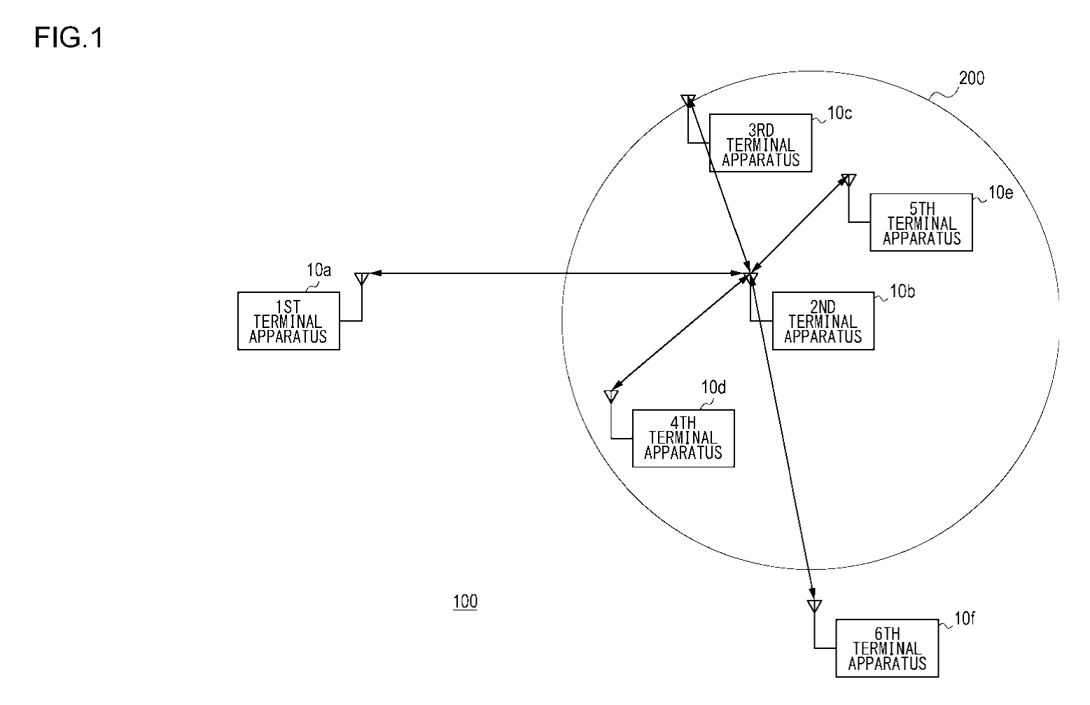

FIG. 1 shows a structure of a communication system 100 according to the first exemplary embodiment. The communication system 100 includes a first terminal apparatus 10a, a second terminal apparatus 10b, a third terminal apparatus 10c, a fourth terminal apparatus 10d, a fifth terminal apparatus 10e, and a sixth terminal apparatus 10f, which are generically referred to as “terminal apparatus 10” or “terminal apparatuses 10”. Each terminal apparatus 10 is compatible with a common radio communication scheme.

The first terminal apparatus 10a corresponds to the above-described initial terminal apparatus, and creates a group to be formed by a plurality of terminal apparatuses 10. The group, which is created at this stage, includes the first terminal apparatus 10a and the second terminal apparatus 10b only and does not includes the rest of the terminal apparatuses 10. The first terminal apparatus 10a transmits the first request signal to the second terminal apparatus 10b. The first request signal is a signal used to request the collection of other terminal apparatuses 10 that are to participate in the group. The first request signal also contains the range data.

The second terminal apparatus 10b corresponds to the above-described substituting terminal apparatus, and acts on behalf of the first terminal apparatus 10a (namely, the second terminal apparatus 10b is used in substitution for the first terminal apparatus 10a). The second terminal apparatus 10b collects other terminal apparatuses 10 that are to participate in the group. The second terminal apparatus 10b not only acquires its own positional information but also generates the second request signal so that the range data and the positional data contained in the first request signal can be contained in the second request signal. An area surrounded by the range data with the positional information located in the center of the area is indicated by an area 200 in FIG. 1. The second terminal apparatus 10b broadcasts the second request signal. The second request is a signal used to request other terminals apparatuses 10 to participate in the group.

The third terminal apparatus 10c to the sixth terminal apparatus 10f each receives the second request signal. These terminal apparatuses 10c to 10f identify the position of the area 200, based on the positional information and the range data contained in the second request signal. These terminal apparatuses 10c to 10f acquires their own positional information, respectively, and determine if their own positional information is contained in the area 200 (namely, determines if their own positional information indicates that the terminal apparatus 10 is located within the area 200). If the positional information is contained in the area 200, it will be determined that the terminal apparatus 10 participates in the group. Assume herein that the third terminal apparatus 10c to the fifth terminal apparatus 10e are determined to be participated and included in the group and that the sixth terminal apparatus 10f is determined not to be participated and included in the group.

As a result of this processing as described above, the first terminal apparatus 10a to the fifth terminal apparatus 10e are now included in the group. Once the group is created, any one of the first terminal apparatus 10a to the fifth terminal apparatus 10e makes an initial call and the rest thereof listens to the voice received therefrom. Note here that the terminal apparatus 10 of the initial call and a voice receiving terminal 10 may be switched therebetween within the group.

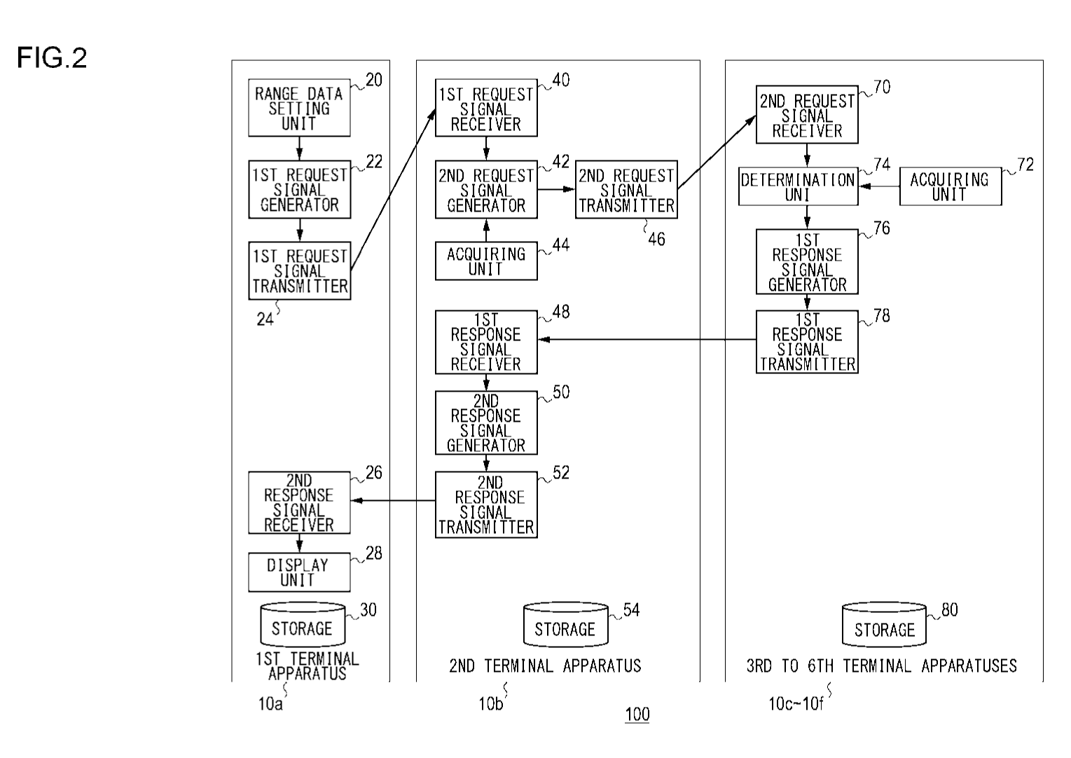

FIG. 2 shows a structure of the communication system 100. FIG. 2 shows structures of the first terminal apparatus 10a to the sixth terminal apparatus 10f in further detail. The first terminal apparatus 10a includes a range data setting unit 20, a first request signal generator 22, a first request signal transmitter 24, a second response signal receiver 26, a display unit 28, and a storage 30. The second terminal apparatus 10b includes a first request signal receiver 40, a second request signal generator 42, an acquiring unit 44, a second request signal transmitter 46, a first response signal receiver 48, a second response signal generator 50, a second response signal transmitter 52, and a storage 54. The third terminal apparatus 10c to the sixth terminal apparatus 10f each includes a second request signal receiver 70, an acquiring unit 72, a determination unit 74, a first response signal generator 76, a first response signal transmitter 78, and a storage 80.

In the first terminal apparatus 10a, the range data setting unit 20 generates range data indicating a range where the other terminal apparatuses 10, which can possibly participate in or subscribe to the group, are to be located. The range data is constructed by data such as a radius W of 10 m, for example, and corresponds to the distance from the second terminal apparatus 10b. The radius W in the range data is specified by a numerical value. If the radius W is a fixed distance, the range data setting unit 20 only stores the fixed radius W.

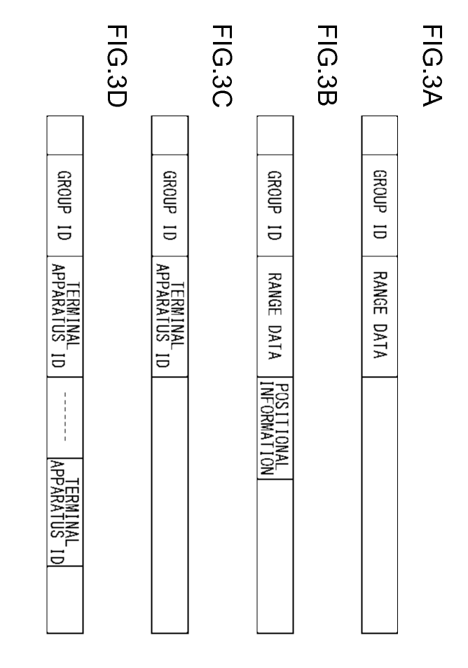

The first request signal generator 22 generates a first request signal that is used to request the collection of other terminal apparatuses 10 participating in the group. The first request signal contains the range data, fed from the range data setting unit 20, and identification information (hereinafter referred to as a “group ID”) by which to identify a group to be created. The first request signal transmitter 24 transmits the first request signal, which has been generated by the first request signal generator 22, to the second terminal apparatus 10b. Note that the number of terminal apparatuses 10 to which the first request signal is sent may be “two” or more. FIGS. 3A to 3D each shows a format of signal transmitted by the communication system 100. FIG. 3A shows a format of the first request signal transmitted from the first request signal transmitter 24. As shown in FIG. 3A, the format thereof contains at least a group ID and range data. FIGS. 3B to 3D will be discussed later. Now refer back to FIG. 2. The storage 30 stores the group ID to be set, and the like.

In the second terminal apparatus 10b, the first request signal receiver 40 receives the first request signal sent from the first request signal transmitter 24. The first request signal contains the range data and the group ID. Receiving the first request signal by the first request signal receiver 40 starts a joining-the-group processing. The acquiring unit 44 acquires the positional information on the second terminal apparatus 10b. Although, for example, a global positioning system (GPS) may be used for the acquisition of the positional information, other devices such as a mobile phone and an RFID (Radio Frequency IDentifier) may be used instead. The positional information may be manually entered into the acquiring unit 44. The positional information is indicated by the latitude and longitude.

When the first request signal receiver 40 receives the first request signal, the second request signal generator 42 generates a second request signal. Here, the second request signal is a signal used to request other terminal apparatuses 10 to participate in the group to which the first terminal apparatus 10a and the second terminal apparatus 10b belong. The range data and the group ID contained in the first request signal and the positional information acquired by the acquiring unit 44 are included in the second request signal. The second request signal transmitter 46 transmits the second request signal generated by the second request signal generator 42. Since the second request signal is transmitted to the third to sixth terminal apparatuses 10c to 10f, which are located around the second terminal apparatus 10b, the transmission of the second request signal corresponds to the broadcasting of the second request signal here. FIG. 3B shows a format of the second request signal transmitted from the second request signal transmitter 46. As shown in FIG. 3B, the format thereof contains at least a group ID, range data and positional information. FIGS. 3C and 3D will be discussed later. Now refer back to FIG. 2. The group ID is set in the storage 54.

In the third terminal apparatus 10c to the sixth terminal apparatus 10f, the second request signal receivers 70 each receives the second request signal sent from the second request signal transmitter 46. As each second request signal receiver 70 receives the second request signal, each acquiring unit 72 acquires the positional information similarly to the acquiring unit 44. Each determination unit 74 extracts the range data, the group ID and the positional information from the second request signal received by the second request signal receiver 70. The determination unit 74 creates a circle, where the position indicated by the positional information is the center, having the radius W specified by the range data. The thus created circle is the aforementioned area 200. The determination unit 74 determines whether or not the positional information fed from the acquiring unit 72 is within the area 200. If the positional information is within the area 200, it is determined that the terminal apparatus participates in (joins) the group; if not, it is determined that the terminal apparatus does not join the group. The determination unit 74 outputs the determination result.

If the participation in the group is determined by the determination unit 74, the first response signal generator 76 generates, as a response to the second request signal, a first response signal indicating that the terminal apparatus 10 participates in the group. In FIG. 1, the first response signal generators 76 included respectively in the third terminal apparatus 10c to the fifth terminal apparatus 10e generate the first response signals. In other words, the first response signal is said to be an ACK (ACKnowledgement) to the second request signal. The first response signal contains the group ID, extracted by the determination unit 74, and the identification information by which to identify the terminal apparatus 10 (hereinafter referred to as “terminal apparatus ID”). If non-participation in the group is determined by the determination unit 74, the first response signal generator 76 may not generate the first response signal or may generate ACK indicating non-participation. Assume herein that no first response signal is generated. The first response signal transmitter 78 transmits the first response signal generated by the first response signal generator 76. FIG. 3C shows a format of the first response signal transmitted from the first response signal transmitter 78. As shown in FIG. 3C, the format thereof contains at least a group ID and a terminal apparatus ID. FIG. 3D will be discussed later. Now refer back to FIG. 2. The group ID is set in the storage 80.

In the second terminal apparatus 10b, the first response signal receiver 48 receives the first response signals sent from the first response signal transmitters 78 in the third terminal apparatus 10c to the fifth terminal apparatus 10e of FIG. 1. The second response signal generator 50 extracts the group IDs and the terminal apparatus IDs from a plurality of first response signals received respectively by the first response signal receiver 48. The second response signal generator 50 generates a second response signal by combining or putting together a plurality of terminal apparatus IDs. The second response signal is a signal that contains the information on other terminal apparatuses 10 participating in the group. The second response signal generator 50 may generate the second response signal without combining or putting together the plurality of terminal apparatus IDs. In that case, the content of the information contained in the second response signal is the same as that of the information contained in the first response signal.

The second response signal transmitter 52 transmits the second response signal, generated by the second response signal generator 50, to the first terminal apparatus 10a. FIG. 3D shows a format of the second response signal transmitted from the second response signal transmitter 52. As shown in FIG. 3D, the format thereof contains at least a group ID and terminal IDs of the plurality of terminal apparatuses 10 that have transmitted the first response signals. Now refer back to FIG. 2.

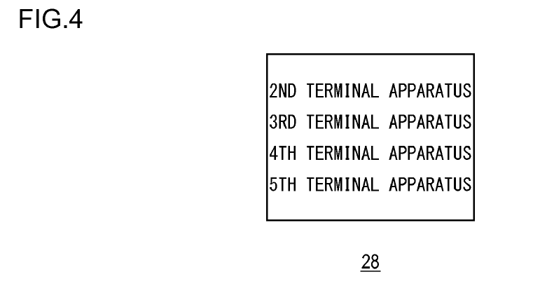

In the first terminal apparatus 10a, the second response signal receiver 26 receives the second response signal sent from the second response signal transmitter 52. The second response signal receiver 26 extracts the plurality of terminal apparatus IDs contained in the second response signal. The second response signal receiver 26 registers the extracted plurality of terminal apparatus IDs, the first terminal apparatus 10a and the second terminal apparatus 10b as a plurality of terminal apparatuses 10 that form the group. The display unit 28 displays, in a list form, the plurality of terminal apparatuses 10 registered by the second response signal receiver 26. FIG. 4 shows a screen displayed on the display unit 28. As shown in FIG. 4, a plurality of terminal apparatuses 10 forming the group are shown.

The information concerning the plurality of terminal apparatuses 10 registered by the second response signal receiver 26 is transmitted from the first terminal apparatus 10a to the other terminal apparatuses 10 within the group, so that the information concerning them is shared by the other terminal apparatuses 10. Under these circumstances, a call processing in the group is carried out such that any one of the terminal apparatuses 10 is assigned to the initial-call terminal apparatus 10 and then the rest of the terminal apparatuses 10 are assigned to the voice-receiving terminal apparatuses 10. Known art may be used for the call processing and therefore the description thereof is omitted here. Even though the information is not shared, the call processing in the group may be carried out by using the group IDs stored in the storage 30, the storage 54 and the storages 80.

These structural components may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

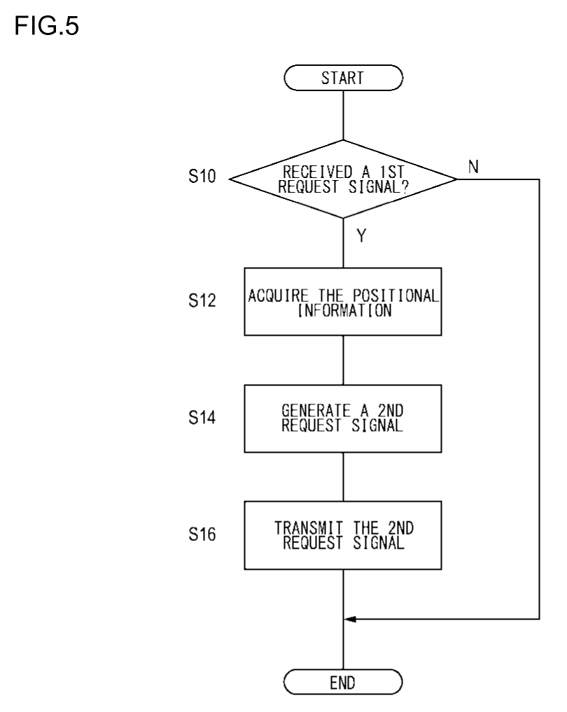

An operation of the communication system 100 configured as above is now explained. FIG. 5 is a flowchart showing a procedure in which the second request signal is transmitted by the second terminal apparatus 10b. If the first request signal receiver 40 has received a first request signal (Y of S10), the acquiring unit 44 acquires the positional information (S12). The second request signal generator 42 generates a second request signal (S14). The second request signal transmitter 46 transmits the second request signal (S16).

If the first request signal receiver 40 does not receive the first request signal (N of S10), the Step S12 to Step S16 are skipped.

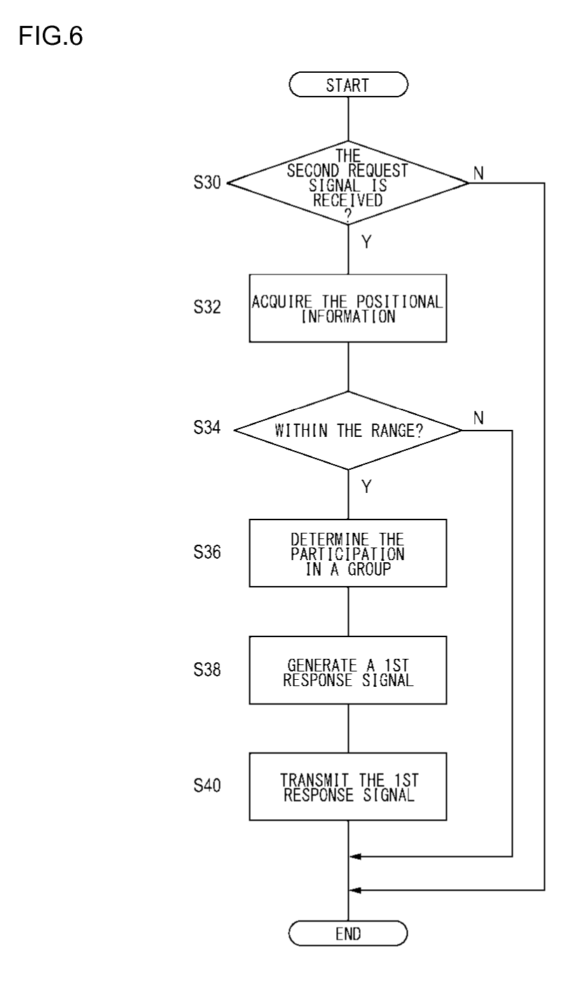

FIG. 6 is a flowchart showing a procedure in which the first response signal is transmitted by the third terminal apparatus 10c. If the second request signal receiver 70 has received the second request signal (Y of S30), the acquiring unit 72 acquires the positional information (S32). If the positional information is within the area 200 (Y of S34), the determination unit 74 determines that a terminal apparatus participates in the group (S36). The first response signal generator 76 generates a first response signal (S38). The first response signal transmitter 78 transmits the first response signal (S40). If the second request signal receiver 70 does not receive the second request signal (N of S30), the Step S32 to Step S40 are skipped. If not within the area 200 (N of S34), the Step S36 to the Step S40 are skipped.

By employing the first exemplary embodiment, the substituting terminal apparatus, which has received the first request signal sent from the initial terminal apparatus, transmits the second request signal. Thus, other terminal apparatuses located near the substituting terminal apparatus can be included in the group. Also, those other terminal apparatuses located near the substituting apparatus are included in the group. Thus a group, which includes a plurality of terminal apparatuses located within a predetermined area, can be formed by the initial terminal apparatus.

Also, the first request signal contains the range data, and the second request signal contains the range data and the positional information, so that the position of the area can be specified. Also, the group ID is contained in the first request signal and the second request signal. Thus a group can be identified even though a plurality of groups are defined. Also, the first response signal and the second response signal each contains the information on other terminal apparatuses belonging to the group. Thus those other terminal apparatuses included in the group can be recognized.

### Second Exemplary Embodiment

A second exemplary embodiment is now explained. Similar to the first exemplary embodiment, the second exemplary embodiment relates to a communication system that forms a group by a plurality of terminal apparatuses and performs a group call among the terminal apparatuses within the group. In the first exemplary embodiment, a first radio communication scheme and a second radio communication scheme are put to a common use. Here, the first radio communication scheme is the scheme used when the first request signal and the second response signal are transmitted between the initial terminal apparatus and the substituting terminal apparatus. The second radio communication scheme is the scheme used when the second request signal and the first response signal are transmitted between the substituting terminal apparatus and other terminal apparatuses. In the second exemplary embodiment, however, the first radio communication scheme and the second radio communication scheme differ from each other, and a short-range communication is used for the latter (the second radio communication scheme). A communication system 100 according to the second exemplary embodiment is of a type similar to that of FIG. 1. A description is given hereinbelow centering around the features different from the first exemplary embodiment.

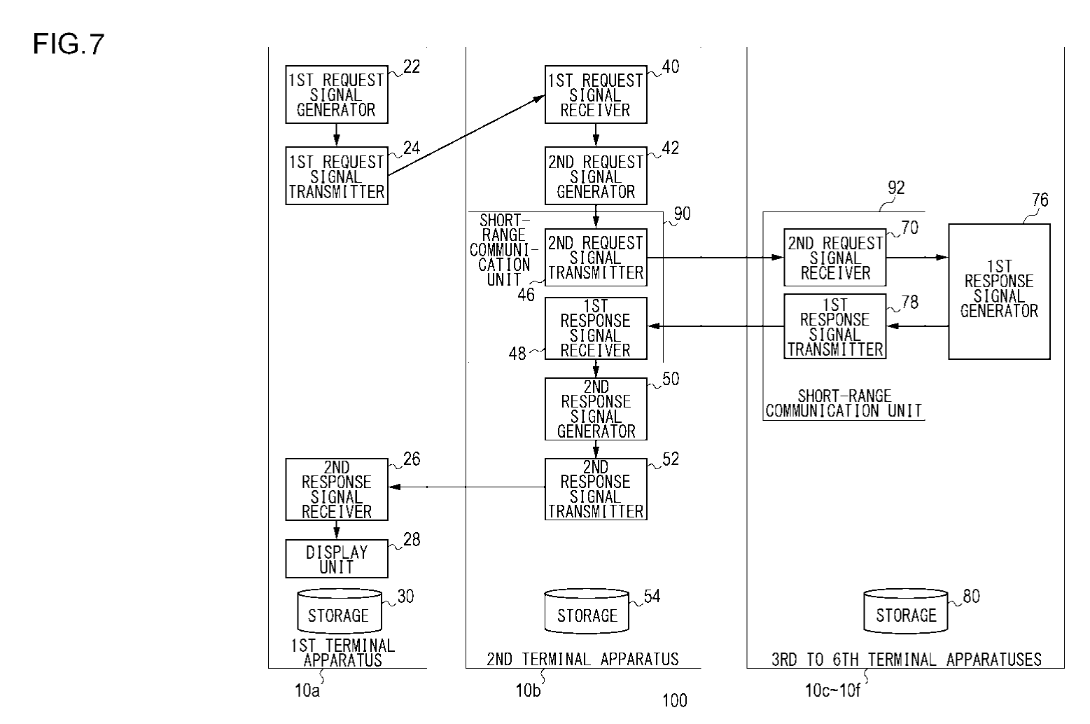

FIG. 7 shows a structure of the communication system 100 according to the second exemplary embodiment. A first terminal apparatus 10a includes a first request signal generator 22, a first request signal transmitter 24, a second response signal receiver 26, and a display unit 28. A second terminal apparatus 10b includes a first request signal receiver 40, a second request signal generator 42, a short-range communication unit 90, a second response signal generator 50, and a second response signal transmitter 52. The short-range communication unit 90 includes a second request signal transmitter 46 and a first response signal receiver 48. A third terminal apparatus 10c to a sixth terminal apparatus 10f each includes a short-range communication unit 92 and a first response signal generator 76. The short-range communication unit 92 includes a second request signal receiver 70 and a first response signal transmitter 78.

In the first terminal apparatus 10a, the first request signal generator 22 generates a first request signal. Unlike the first exemplary embodiment, the range data is not contained in the first request signal in the second exemplary embodiment. The first request signal transmitter 24 transmits the first request signal, generated by the first request signal generator 22, to the second terminal apparatus 10b.

In the second terminal apparatus 10b, the first request signal receiver 40 receives the first request signal from the first request signal transmitter 24. If the first request signal receiver 40 has received the first request signal, the second request signal generator 42 generates a second request signal. In contrast to the first exemplary embodiment, the range data and the positional information are not contained in the second request signal in the second exemplary embodiment. The second request signal transmitter 46 and the first response signal receiver 48 are included in the short-range communication unit 90. The second request signal transmitter 46 has a transmitting function for a short-range communication, and the first response signal receiver 48 has a receiving function for the short-range communication. The short-range communication includes, for example, Bluetooth (registered trademark), infrared communication, and so forth. Assume herein that Bluetooth (registered trademark) is used. The second request signal transmitter 46 carries out the short-range communication and thereby transmits the second request signal generated by the second request signal generator 42. This corresponds to a processing where the second terminal apparatus 10b of FIG. 1 performs a pairing on the third terminal apparatus 10c to the sixth terminal apparatus 10f.

In each of the third terminal apparatus 10c to the sixth terminal apparatus 10f, the short-range communication unit 92 includes the second request signal receiver 70 and the first response signal transmitter 78. The second request signal receiver 70 has a receiving function for the short-range communication, and the first response signal transmitter 78 has a transmitting function for the short-range communication. The second request signal receiver 70 receives the second request signal sent from the second request signal transmitter 46. If the second request signal receiver 70 has received the second request signal, then the second request signal receiver 70, the first response signal generator 76 and the first response signal transmitter 78 perform the pairing processing with the short-range communication unit 90. Known art may be used for the pairing processing and therefore the description thereof is omitted here. If the pairing processing is successful, the first response signal generator 76 generates a first response signal indicating that the terminal apparatus 10 participates in the group. The first response signal transmitter 78 transmits the first response signal generated by the first response signal generator 76.

In the second terminal apparatus 10b, the first response signal receiver 48 receives, through the short-range communication, the first response signal sent from the first response signal transmitter 78 in each of the third terminal apparatus 10c to the fifth terminal apparatus 10e of FIG. 1. On the other hand, the sixth terminal apparatus 10f of FIG. 1 is located far away from the second terminal apparatus 10b. Thus the short-range communication is not carried out between the second terminal apparatus 10b and the sixth terminal apparatus 10f. As a result, the first response signal receiver 48 does not receive the first response signal sent from the sixth terminal apparatus 10f. The second response signal generator 50 generates a second response signal, and the second response signal transmitter 52 transmits the second response signal, generated by the second response signal generator 50, to the first terminal apparatus 10a.

After a plurality of terminal apparatuses 10 included in the group have been registered through the above-described processing, a call processing in the group is carried out such that any one of the registered terminal apparatuses 10 is assigned to the initial-call terminal apparatus 10 and then the rest of the terminal apparatuses 10 are assigned to the voice-receiving terminal apparatuses 10. During this call processing, the third terminal apparatus 10c to the fifth terminal apparatus 10f of FIG. 1 do not use the short-range communications, and one commonly used radio communication scheme is used among all of the terminal apparatuses 10 in the group. Even though a plurality of terminal apparatuses 10 included in the group are not registered, the call processing in the group may be carried out by using the group IDs stored in the storage 30, the storage 54 and the storages 80.

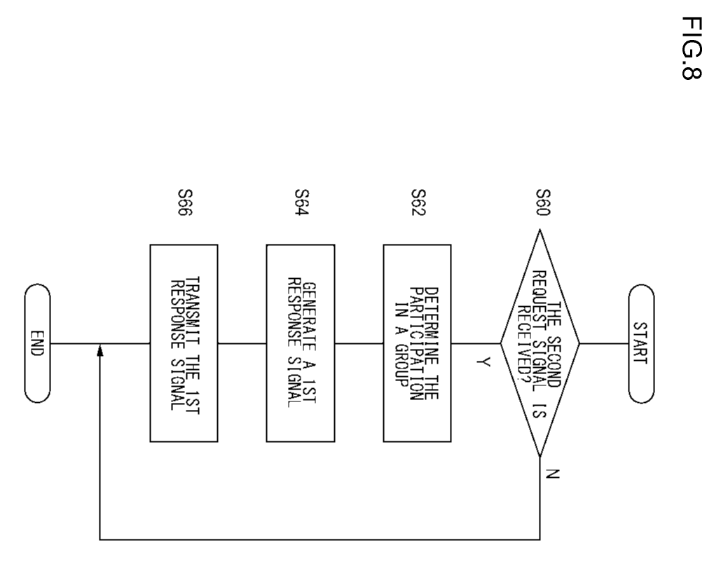

FIG. 8 is a flowchart showing a procedure in which a first response signal is transmitted by the third terminal apparatus 10c.

If the second request signal receiver 70 has received a second request signal (Y of S60), the first response signal generator 76 determines that a terminal apparatus participates in the group (S62). The first response signal generator 76 generates the first response signal (S64). The first response signal transmitter 78 transmits the first response signal (S66). If the second request signal receiver 70 does not receive the second request signal (N of S60), the Step S62 to Step S60 are skipped.

By employing the second exemplary embodiment, the second request signal is transmitted in the short-range communication, so that other terminal apparatuses, which are located near the substituting terminal apparatus, can be participated in the group without having to transmit the range data. Also, the range data is not contained in the first request signal and the second request signal, so that the transmission efficiency can be improved.

The present invention has been described based on the exemplary embodiments. The exemplary embodiments are intended to be illustrative only, and it is understood by those skilled in the art that various modifications to constituting elements and processes as well as arbitrary combinations thereof could be further developed and that such modifications and combinations are also within the scope of the present invention.

In the first and second exemplary embodiments, when the joining-the-group processing and the call processing are to be done, the communications are carried out directly between the terminal apparatuses 10 without involving any base station apparatus. However, this should not be considered as limiting and, for example, the communications may be carried out between the terminal apparatuses 10 through the base station apparatus. A wireless communication system for business or commercial use may be used as the communications carried out between the terminal apparatuses 10 via the base station apparatus. A group including a plurality of terminal apparatuses 10 is formed also in the wireless communication system for business or commercial use. Also, the base station apparatus allots a channel in units of group. Thereby, a terminal apparatus 10 included in a group, to which a channel has been allocated, communicates with the rest of terminal apparatuses 10 included in this group. By employing this modification, the degree of freedom in configuring the communication system 100, namely the structural flexibility of the communication system 100, can be enhanced.

In the first and second exemplary embodiments, the joining-the-group processing is done before the call processing. However, this should not be considered as limiting and, for example, the first terminal apparatus 10a may transmit the first request signal simultaneously with the call. The second terminal apparatus 10b receives the first request signal while receiving the voice, and then transmits the second request signal. By employing this modification, the call is performed in a group reflecting the most recent position of the terminal apparatus 10.

In the first and second exemplary embodiments, the group IDs are contained in the first request signal, the second request signal, the first response signal and the second response signal. However, this should not be considered as limiting and, for example, the group IDs may not be contained in these signals. The group IDs may be transmitted separately from these signals, or the group IDs may not be transmitted at all. The case where the group IDs are not transmitted at all corresponds to the case where a single group is formed. In this case, each terminal apparatus 10 stores the fixed group ID and a flag indicating whether or not the terminal apparatus 10 has participated in the group. By employing this modification, the degree of freedom in the configuration can be enhanced.

What is claimed is:

1. A terminal apparatus substituting an initial terminal apparatus, which creates a group to be formed by a plurality of terminal apparatuses, the terminal apparatus collecting another terminal apparatus participating in the group, the terminal apparatus comprising:
a request receiver that receives, from the initial terminal apparatus, a first request signal by which to request collection of the other terminal apparatus participating in the group; and
a request transmitter that transmits a second request signal by which to request the other terminal apparatus to participate in the group, when the request receiver has received the first request signal.

2. A terminal apparatus according to claim 1, further comprising an acquiring unit that acquires positional information on the terminal apparatus,
wherein the first request signal received by the request receiver contains information concerning a range where another terminal apparatus possibly participating in the group is located, and
wherein the information, concerning the range, contained in the first request signal and the positional information acquired by the acquiring unit are included in the second request signal transmitted from the request transmitter.

3. A terminal apparatus according to claim 1, wherein the request transmitter carries out short-range communication.

4. A terminal apparatus according to claim 1, wherein the first request signal received by the request receiver contains identification information used to identify the created group, and
wherein the second request signal transmitted from the request transmitter contains the identification information contained in the first request signal.

5. A terminal apparatus according to claim 1, further comprising:
a response receiver that receives a first response signal, which indicates that another terminal apparatus participates in the group, as a response to the second request signal transmitted from the request transmitter, from the other terminal apparatus; and
a response transmitter that transmits a second response signal, which contains information concerning the other terminal apparatus participating in the group, to the initial terminal apparatus, when the response receiver has received the first response signal.

6. A communication system comprising:
a first terminal apparatus that creates a group to be formed by a plurality of terminal apparatuses; and
a second terminal apparatus that substitutes the first terminal apparatus and that collects another terminal apparatus participating in the group,
wherein the first terminal apparatus transmits a first request signal, by which to request collection of the other terminal apparatus participating in the group, to the second terminal apparatus, and
wherein, when the second terminal apparatus has received the first request signal, the second terminal apparatus transmits a second request signal by which to request the other terminal apparatus to participate in the group.

7. A communication method in a terminal apparatus substituting an initial terminal apparatus, which creates a group to be formed by a plurality of terminal apparatuses, the terminal apparatus collecting another terminal apparatus participating in the group, the communication method comprising:
receiving, from the initial terminal apparatus, a first request signal by which to request collection of the other terminal apparatus participating in the group; and
transmitting a second request signal by which to request the other terminal apparatus to participate in the group, when the first request signal has been received.
